(19) United States
(12) Patent Application Publication
(10) Pub. No.: US 2010/0066814 A1
(43) Pub. Date: Mar. 18, 2010

(54) METHOD CAPABLE OF GENERATING REAL-TIME 3D MAP IMAGES AND NAVIGATION SYSTEM THEREOF

(76) Inventor: Pin-Hsien Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/470,477

(22) Filed: May 21, 2009

(30) Foreign Application Priority Data
Sep. 12, 2008 (TW) 097135035

(51) Int. Cl. H04N 13/02; G01C 21/00

(52) U.S. Cl. 348/47; 701/212; 348/E13.074

(57) ABSTRACT

A method for generating real-time 3D images includes capturing a first image and a second image corresponding to an area at different visual angles respectively, generating area map data according to the location of the area, generating and outputting a 3D image according to the first image and the second image, and displaying the area map data on the outputted 3D image.

### BACKGROUND OF THE INVENTION

1. Field of the Invention

The present invention relates to a method for generating images and a navigation system thereof, and more specifically, to a method capable of generating real-time 3D map images and a navigation system thereof.

2. Description of the Prior Art

With development of satellite positioning technology, a GPS is widely used in daily life. A navigation device is one of the most representative examples. A powerful navigation system may provide navigation images with various map information and multiple navigation functions to a vehicle driver by way of simple 2D map images or 3D map images. However, since both the said 2D map images and 3D map images need to be constructed in advance by art designers according to map data obtained from an on-the-spot investigation process performed by map data maintenance staff, a considerable difference may exist between real scenes viewed by a vehicle driver and map images provided from a navigation device, which may lead the vehicle driver to make a wrong decision in map identification and path finding.

Furthermore, for traditional map data updating, a navigation system company usually needs to dispatch map data maintenance staff to perform on-the-spot investigation processes frequently. Thus, not only is the said method time-consuming and strenuous, but brings about slow map data updating speed. Thus, a traditional navigation device is usually incapable of providing precise and real-time map information to a vehicle driver. Summary of the Invention

The present invention provides a method for generating real-time 3D images, the method comprising capturing a first image and a second image corresponding to an area at different visual angles respectively; generating area map data according to the location of the area; generating and outputting a 3D image according to the first image and the second image; and displaying the area map data on the outputted 3D image.

The present invention further provides a navigation system capable of generating real-time 3D images, the navigation system comprising a first image capturing device for capturing a first image corresponding to an area; a second image capturing device for capturing a second image corresponding to the area, the first image and the second image having different visual angles; and a navigation module electrically connected to the first image capturing device and the second image capturing device, the navigation module comprising a map data processing device for generating corresponding area map data according to the area; an image control device for generating a 3D image according to the first image and the second image; and a display device for outputting the 3D image, the image control device further used for controlling the display device to display the area map data on the outputted 3D image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a navigation system according to an embodiment of the present invention.

FIG. 2 is a flowchart of a method capable of generating a real-time 3D map image according to an embodiment of the present invention.

### DETAILED DESCRIPTION

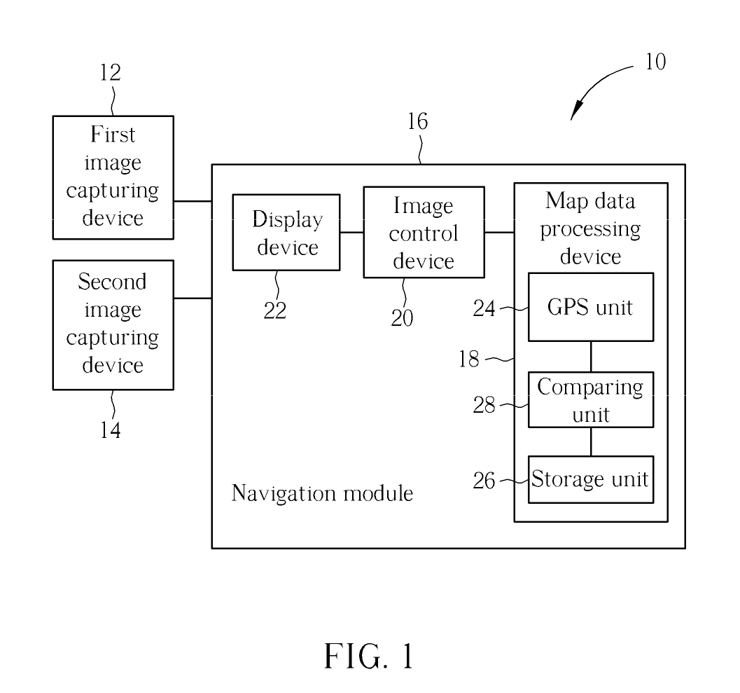

Please refer to FIG. 1, which is a functional block diagram of a navigation system 10 according to an embodiment of the present invention. The navigation system 10 comprises a first image capturing device 12, a second image capturing device 14, and a navigation module 16. The first image capturing device 12 is used for capturing a first image corresponding to an area. The second image capturing device 14 is used for capturing a second image corresponding to the area. The first image capturing device 12 and the second image capturing device 14 are common image capturing apparatuses, such as cameras, video cameras, and so on. The first image and the second image mentioned above have different visual angles, meaning that the first image capturing device 12 and the second image capturing device 14 capture the first image and the second image respectively at different shooting angles in the said area. The navigation module 16 is electrically connected to the first image capturing device 12 and the second image capturing device 14. The navigation module 16 comprises a map data processing device 18, an image control device 20, and a display device 22. The map data processing device 18 is used for generating corresponding area map data according to the area. The map data processing device 18 comprises a GPS (Global Positioning System) unit 24, a storage unit 26, and a comparing unit 28. The GPS unit 24 is used for obtaining corresponding location data according to the area, such as longitude and latitude coordinates. The storage unit 26 is used for storing map related data. The comparing unit 28 is electrically connected to the GPS unit 24 and the storage unit 26 for comparing the location data with the map related data to generate the area map data. The image control device 20 is used for generating a 3D image according to the first image and the second image. The display device 22 is used for outputting the 3D image. The display device 22 may be a common image display apparatus, such as a LCD (Liquid Crystal Display). Furthermore, the image control device 20 may be further used for controlling the display device 22 to display the area map data on the outputted 3D image.

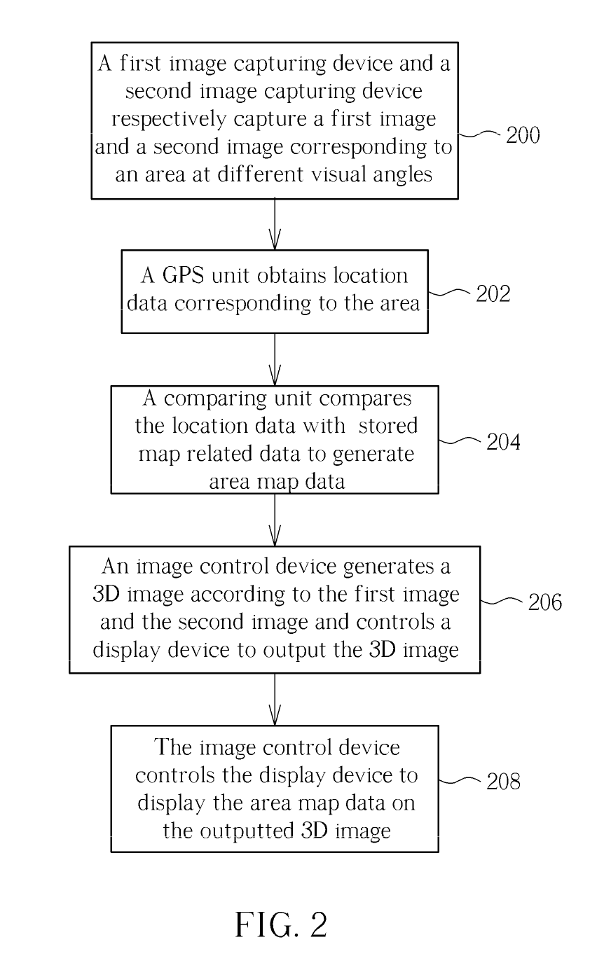

Next, please refer to FIG. 2. FIG. 2 is a flowchart of a method capable of generating a real-time 3D map image according to an embodiment of the present invention. The method comprises the following steps.

Step 200: The first image capturing device 12 and the second image capturing device 14 capture the first image and the second image corresponding to the area respectively at different visual angles.

Step 202: The GPS unit 24 obtains location data corresponding to the area.

Step 204: The comparing unit 28 compares the location data with map related data stored in the storage unit 26 to generate corresponding area map data.

Step 206: The image control device 20 generates the 3D image according to the first image and the second image and controls the display device 22 to output the 3D image.

Step 208: The image control device 20 controls the display device 22 to display the area map data on the outputted 3D image.

More detailed description for how the navigation system 10 generates the real-time 3D map image is provided as follows. Please refer to FIG. 1 and FIG. 2 at the same time. When a user starts the navigation system 10 while driving a car, the first image capturing device 12 and the second image capturing device 14 in the navigation system 10 may respectively start to capture images in front of the car (i.e. the area mentioned in Step 200) at different shooting angles (Step 200) for generating the corresponding first image and second image. As mentioned above, the content of the first image and the content of the second image are substantially identical but differ in the visual angles. When the first image capturing device 12 and the second image capturing device 14 in the navigation system 10 respectively capture the first image and the second image at different shooting angles, the GPS unit 24 obtains the location data (e.g. longitude and latitude coordinates of the area) corresponding to the area at the same time (Step 202). Subsequently, the comparing unit 28 in the map data processing device 18 may compare the location data transmitted from the GPS unit 24 with the map related data stored in the storage unit 26, and then obtain the area map data corresponding to the location data from the map related data (Step 204). The map related data stored in the storage unit 26 may be map data corresponding to a predetermined geographical range, such as map data for Taipei, and the said area map data corresponds to map navigation information for a certain district in the predetermined geographical range, e.g. a certain crossroads in Taipei, such as road names, road guides, speed limits, traffic conditions, and so on. Next, in Step 206, the image control device 20 generates the 3D image according to the first image transmitted from the first image capturing device 12 and the second image transmitted from the second image capturing device 14, and then controls the display device 22 to output the 3D image. In this embodiment, the image control device 20 controls the display device 22 to display the 3D image by an auto-stereoscopic display method. The auto-stereoscopic display method allows the user to view 3D images without wearing 3D glasses. Common methods include an e-holographic method, a volumetric method, a multi-planar method, and a multiplexed 2D method. The said multiplexed 2D method is taken as an example for the following description of Step 206.

In general, the multiplexed 2D method involves providing the user's left eye and right eye with planar images at different visual angles via the same display system, respectively. Subsequently, the said planar images at different visual angles may be matched as 3D images, which have focal range and gradation, by vision persistence in the user's brain. The multiplexed 2D method may be divided into two types: spatial-multiplexed and time-multiplexed. In the spatial-multiplexed method, pixel cells in a LCD are divided into odd pixel cells and even pixel cells to form images respectively corresponding to the user's left eye and right eye. Subsequently, the said left eye images and right eye images are projected to the user's left eye and right eye respectively by a lenticular lens so that the user may view 3D images accordingly. The said time-multiplexed method involves controlling a 3D image display apparatus to project images to a user's left eye and the user's right eye sequentially in turns. When image switching speed is fast enough, the said left eye images and right eye images may be matched as 3D images by vision persistence in the user's brain. In other words, in Step 206, if the said spatial-multiplexed method is applied to the image control device 20, the image control device 20 may control the display device 22 to display the first image (e.g. being formed by odd pixel cells) and the second image (e.g. being formed by even pixel cells) at a display speed of thirty frames per second, so that the user's left eye and right eye may view the first image and the second image respectively. In such a manner, the user may view the 3D image matched by the first image and the second image. On the other hand, if the said time-multiplexed method is applied to the image control device 20, the image control device 20 may control the display device 22 to display the first image and the second image sequentially in turns so that the user's left eye and right eye may view the first image and the second image respectively. In this way, the user may also view the 3D image matched by the first image and the second image. Other auto-stereoscopic display methods may also be applied to the image control device 20, such as a multi-planar method.

After the image control device 20 generates the 3D image according to the first image and the second image and controls the display device 22 to output the 3D image, the image control device 20 may control the display device 22 to display the area map data on the outputted 3D image (Step 208). That is to say, when the user views the 3D image, the image control device 20 may also control the display device 22 to display the area map data by an image blending method so that the user may view the 3D image blended with the area map data. Thus, the user may know current traffic information precisely through viewing the real-time 3D image, which has focal range and gradation, and the area map data at the same time via the display device 22 of the navigation system 10. The said image blending technology is commonly used in the prior art. In the following, Step 208 may be further illustrated by way of example, taking reference to an alpha blending technology. First, it should be mentioned that a digital image is composed of many pixels. A pixel is a basic unit in the digital image, and each pixel represents a certain color that is a mix of RGB colors in different proportions. Since 1 byte is needed to display one of the RGB colors, a pixel composed of RGB colors may occupy 3 bytes. However, a pixel in a 32-byte digital image may occupy 4 bytes instead. In other words, besides RGB colors, each pixel in the 32-byte digital image may additionally occupy 1 byte for storing an alpha parameter which represents opacity of the 32-byte digital image. The higher the value of the alpha parameter is, the less transparent the pixel is. Thus, a translucent effect may occur in a 32-byte digital image by way of alpha parameter adjustment. To sum up, in Step 208, the image control device 20 may utilize the said transparent image blending technology to adjust the alpha parameter in the area map data to make the area map data translucent. Thus, after the image control device 20 controls the display device 22 to generate and output the 3D image according to the first image and the second image, the image control device 20 may control the display device 22 to display the translucent area map data at a display speed of thirty frames per second. In such a manner, the user may view the 3D image blended with the area map data.

Compared with the prior art, in which a 3D image module constructed in advance is utilized to provide 3D navigation information to a user, the navigation system provided by the present invention utilizes two image capturing devices to capture surrounding images at different visual angles for generating 3D images so that real-time navigation information may be provided to a user while driving a car. Thus, the navigation system provided by the present invention not only provides accurate traffic conditions based on real-time map data images so that the user may grasp current traffic information quickly, but also helps the user make a correct decision in map identification and path finding through 3D map images.

Those skilled in the art will readily observe that numerous modifications and alterations of the device and method may be made while retaining the teachings of the invention.

What is claimed is:

1. A method for generating real-time 3D images, the method comprising:
capturing a first image and a second image corresponding to an area at different visual angles respectively;
generating area map data according to location of the area;
generating and outputting a 3D image according to the first image and the second image; and
displaying the area map data on the outputted 3D image.

2. The method of claim 1, wherein capturing the first image and the second image corresponding to the area at the different visual angles respectively comprises utilizing a first image capturing device and a second image capturing device to capture the first image and the second image corresponding to the area at the different visual angles respectively.

3. The method of claim 1, wherein generating the area map data according to the location of the area comprises:
obtaining location data of the area; and
comparing the location data with stored map related data to generate the area map data.

4. The method of claim 1, wherein generating and outputting the 3D image according to the first image and the second image comprises generating and outputting the 3D image by an auto-stereoscopic display method.

5. The method of claim 4, wherein generating and outputting the 3D image by the auto-stereoscopic display method comprises generating and outputting the 3D image by a spatial-multiplexed display method or a time-multiplexed display method.

6. A navigation system capable of generating real-time 3D images, the navigation system comprising:
a first image capturing device for capturing a first image corresponding to an area;
a second image capturing device for capturing a second image corresponding to the area, the first image and the second image having different visual angles; and
a navigation module electrically connected to the first image capturing device and the second image capturing device, the navigation module comprising:
a map data processing device for generating corresponding area map data according to the area;
an image control device for generating a 3D image according to the first image and the second image; and
a display device for outputting the 3D image, the image control device further used for controlling the display device to display the area map data on the outputted 3D image.

7. The navigation system of claim 6, wherein the map data processing device comprises:
a GPS unit for obtaining corresponding location data according to the area;
a storage unit for storing map related data; and
a comparing unit electrically connected to the GPS unit and the storage unit, the comparing unit used for comparing the location data with the map related data to generate the area map data.

8. The navigation system of claim 6, wherein the image control device is used for controlling the display device to generate the 3D image by an auto-stereoscopic display method.

9. The navigation system of claim 8, wherein the image control device is used for controlling the display device to generate the 3D image by a spatial-multiplexed display method or a time-multiplexed display method.

10. The navigation system of claim 6, wherein the first image capturing device and the second image capturing device are cameras or video cameras.

11. The navigation system of claim 6, wherein the display device is a LCD.
